(19) United States
(12) Patent Application Publication
(10) Pub. No.: US 2003/0066819 A1
(43) Pub. Date: Apr. 10, 2003

(54) Resonance controlled conductive heating

(75) Inventors: Hamid Reza Shahani Shargh, Quebec (CA); Marie Gagnon, Quebec (CA); Majid Shahani shargh, Quebec (CA)

Correspondence Address: BAKER & HOSTETLER LLP, Washington Square, Suite 1100, 1050 Connecticut Avenue, N.W., WASHINGTON, DC, 20036, US

(73) Assignee: NORAX CANADA, INC.

(21) Appl. No.: 10/256,196

(22) Filed: Sep. 27, 2002

(30) Foreign Application Priority Data
Oct. 9, 2001 (CA) 2,358,602

(51) Int. Cl. H05B 1/00

(52) U.S. Cl. 219/50; 219/155; 219/156

(57) ABSTRACT

A resonance controlled conductive heating apparatus for heating a conductive load, has input terminals for receiving AC power. The primary winding of a transformer is coupled to the input terminals. First and second electrodes are coupled to the secondary winding of the transformer and are adapted respectively to electrically engage the conductive load in first and second contact points spaced from each other for direct passage of current therebetween. A resonant circuit is coupled between the secondary winding of the transformer and the electrodes. The resonant circuit has inductance, capacitance, voltage and operating frequency properties set to control a maximum current flowing across the conductive load between the electrodes.

### FIELD OF THE INVENTION

The present invention relates to conductive heating, and more particularly to a resonance controlled conductive heating apparatus and an associated method.

### BACKGROUND

In conventional conduction heating of wires, rods, strips, stranded wire, metallic parts, heating elements, etc., a DC or 60 Hz current is passed through the material of the load. Rollers or similar collectors can be used to make the electrical contact between the power source and the load at two or more contact points spaced from each other. U.S. Pat. No. 4,090,058 (Kielhorn et al.) shows a conductive heating device using such rollers. The output of the DC or 60 Hz source is directly connected to the load by a pair of such collectors. The heat in the load is generated due to the resistivity of the material and the Joule effect. Due to the high conductivity of metallic materials, high currents must be applied to generate sufficient heat for many industrial applications. The high currents in these cases are similar to “short circuit” conditions in an electrical circuit. The load as well as the electrical cables and bus bars and collectors get easily overheated. The arcing at the contact points can be intense and sever due to high currents. The maximum current depends on the resistivity of the material, applied voltage between the contact points, power rating and internal resistance of the power source or the step-down transformer possibly used, and also the quality of the contact points.

In DC or 60 Hz current, electrons migrate through the whole material's cross-section. This results that all the cross-section of the wire or rod be available to carry the electrons and results in low DC resistivity of the material as mentioned earlier. The calculations in case of wire heating are simpler, and thus are presented as an illustrative example. The same mechanism is applicable to other shapes and materials. The resistivity of the wire under DC current is determined by its physical dimensions and in case of a rod or wire:

R=ρL/S

where ρ is the specific resistance, L is the length and S is the cross-section surface.

As an example, let assume that it is required that a passing wire has to reach a temperature of 900° C. with the production speed. It is also assumed that 20 kW power has to be delivered to the wire and current can be applied at two points 1 meter apart. The wire has a diameter of 5 mm.

Typical value for the specific resistivity of conventional steel is ρ=10,5×10⁻² (mm²/m). The cross-section of the rod is about 20 mm² and thus the resistance between the contacts is 0,005 Ω at room temperature. The current can be calculated according to Joule's law as:

W=RI² or I=\sqrt{(W/R)}=2000 A

By using Ohm's law, the voltage drop across the wire at the contact points is calculated as 10 V. The voltage supplied from the power source should be higher to compensate additional voltage drops at the bus bars and contact points.

The value of 5 mΩ is a low resistivity and it is in the same range as the internal resistance of most power supplies. Such high currents require heavy and thick connectors and bus bars. The losses in the bus bars and generator are high and intense arcing occurs at the contact points between the collectors and the wire. The arcing damages the surface of the wire causing spots like welding defects.

As another example, the same rod as above is connected to a DC source with a lower amperage rating. The maximum current here is limited to 300 A, using a current source generator, the one supplied by a normal DC welder. The voltage drop between the contact points would be V=300×0,005=1,5 V. The power rating of such system even with good contacts between the electrodes and wire would be 1,5×1,5/0,005=450 W. This amount of energy is not sufficient to generate enough heat in the passing rod.

Resistivity is also a function of temperature and in case of metallic materials increases with temperature and can be calculated as:

R=R(1+αt).

The typical value of α for iron is α=6,6×10⁻³/K.

As a further example, if the rod in the above example is heated uniformly to 900° C., then its resistivity increases 7 times as:

R=R₀ (1+6,6×10^{-3×900})=7R₀ or R=0,005×7=0,035Ω

It is therefore assumed that the resistivity of the passing wire is' the average value between the cold entrance and hot exit after passing the heating zone. As in this example, the average resistivity is then:

(0,035+0,005)/2=0,020 Ω.

The same calculations as in the previous examples indicate that in order to generate 20 kW across the heated passing rod, 1000 A has to be passed and the voltage drop would be 20 V across the contact points.

These indicate that the power source, bus bars and contact points must be able to handle 2000 A at 10 V at the cold start, example 1, and 1000 A at 20 V under production speed and temperature. In the prior art, due to change of the impedance, regulated power supplies such as current source has to be used to avoid excessive rush currents similar to short circuit conditions as mentioned above. In the current source power supplies, current is fixed and applied voltage is regulated accordingly. In normal cases, the expected voltage and current rating are directly proportional together. The problem associated here, as in the examples 1 to 3, is that the power rating of the system is 2000 A at 10 V to 1000 A at 20 V when the part is heated. In this case, both voltage and current have to be varied and in opposite values. In addition, the power rating of the system has to handle 2000 A while be able to deliver 20 V. This corresponds 10 to 40 kW or 2 times that of the required power. Such power source would be more expensive and complicated to manipulate and control the power.

By increasing the frequency of the current, additional heating mechanism generated by the “skin effect” is employed. With increasing the frequency, electrons are pushed closer to the surface of the rod, which is referred to as “skin effect”. The higher the frequency of the current, thinner skin layer will be formed and thus less available path for the electrons to flow. This results in higher resistivity for the same material known as AC resistance. This “skin effect” generates additional heating by “eddy currents” which are not desired in many applications. As an example, overheating of the magnet wires in high frequency applications and transformers. Here “Litz wire” made of many stranded fine insulated wires has to be used, which increases the effective surface and thus reduces eddy currents.

The advantage of increasing the resistivity due to skin effect at high frequency heating is that the voltage across the contact points increases and lower current is required to generate the same amount of heat in comparison with the DC or 60 Hz. The lower current results in less arcing, less damage on the rod and rollers and the efficiency of transferring energy becomes higher. In addition, heat can be generated faster even at the beginning of the process where material is still cold.

The detailed mechanism of the skin effect and its formation is given in the classic textbooks. In a simple explanation, when a current pass through a wire, a magnetic field is formed not only around but also within the wire. This magnetic field inside the wire, which is at right angles to the current direction, in turn induces eddy currents lengthwise along the wire. Depending on the permeability and resistivity of the wire, eddy currents at high frequencies may be considerable. The longitudinal eddy currents travel against the current direction in the center of the wire. This gives a current concentration in the outer edge of the wire and thereby reduces the active area of the wire, which in turn increases the resistance. The term “skin depth” means the depth at which the current density is decreased to 1/e.

This depth is also the same as the wall thickness of a tube of the same length with a DC resistance which corresponds to the AC resistance that the wire would have. This depth can be calculated using the formula:

$$δ = \frac{1}{\sqrt{f μ π ϕ}}$$

where: μ=μ₀·μᵣ=4π×10⁻⁷ μ, with μ₀ being the permeability in absolute vacuum (H/m) and μ, being the relative permeability (assumed to be 250 for iron in the following example), δ is the skin depth (m), f is the frequency, and φ is the conductivity.

The resistivity of the wire then increases with a factor given by:

$${R}_{AC} = {R}_{DC} \times ( \frac{π {r}^{3}}{2 π r δ} ) = {R}_{DC} \times ( \frac{r}{2 δ} )$$

where R_{AC} is the AC resistance, R_{DC} is the DC resistance, r is the radius of the wire, and δ is the skin depth.

As an additional example, let see the case where a transformer is used. The secondary of the transformer is connected to the load directly. The primary is connected to the inverter with switching frequency of f. The problem associated here is the effect of load and impedance variation on the performance of the inverter.

The effect of frequency on the AC resistivity of the same iron wire as in the previous examples is as follows. Conductivity at room temperature is:

1/R=1/(10,5×10⁻⁸)=9,5×10⁶ (m/Ω)

μ₀=4π×10⁻⁷ (H/m)

μᵣ=250

μ=μ₀×μᵣ=250×4π×10⁻⁷

f=20 kHz

δ=0,07

R_{AC}=R_{DC}×2,5/(2×0,07)=17R_{DC}

In this example, the value of resistivity is increased by a factor of 17. This indicates that at cold start, the AC resistance of the rod is increased to 0,05×17=0,085 Ω and the power supply has to deliver: \sqrt{20,000/0,085}=485 A at 41 V.

When the wire is heated, the resistance increases from 0,020 to 0,020×17=0,34 Ω. The power supply delivers 20 kW by applying 240 A at 82 V.

This example shows that by using a 20 kHz inverter, the required current to generate 20 kW in a passing rod reduces from DC 2000 A at 10 V to about 485 A at 41 V at cold start and further on decreases to only 240 A at 82 V when the wire is heated to 900° C. Arcing will be reduced drastically and there is less losses on the conductors and bus bars, collectors and the whole system. However, the maximum power rating of the power source is still 485 A×82 V or 40 kW, about 2 times greater than the required power, similar to the previous cases. As in the previous cases, expectation from the power source is large and the current/voltage are in opposite directions. Applying the current directly from the secondary of the high frequency transformer to the load requires a complicated control system and an over-dimensioned inverter to follow the large changes in the impedance, current and voltage. The control system has to be more complex to accommodate the technical demands and the power source would be more expensive. These together can cause sever problems for the generator and may cause the inverter to fail specially at cold start where the resistance is lower.

### SUMMARY

An object of the invention is to provide a conductive heating apparatus and an associated method which overcome the problems associated with the impedance variation and benefit directly from the conduction heating and skin effect and eddy currents at higher frequencies, to heat-up loads in a more faster and easier fashion.

Another object of the invention is to provide such conductive heating apparatus and method wherein the maximum current passing through the load is unaffected by the resistivity or a change of the resistivity of the load.

According to the present invention, there is provided a resonance controlled conductive heating apparatus for heating a conductive load. The apparatus has input terminals for receiving AC power. The primary winding of a transformer is coupled to the input terminals. First and second electrodes are coupled to the secondary winding of the transformer and are adapted respectively to electrically engage the conductive load in first and second contact points spaced from each other for direct passage of current therebetween. A resonant circuit is coupled between the secondary winding of the transformer and the electrodes. The resonant circuit has inductance, capacitance, voltage and operating frequency properties set to control a maximum current flowing across the conductive load between the electrodes.

According to the present invention, there is also provided a method of performing conductive heating of a conductive load, comprising electrically engaging first and second electrodes with the conductive load in first and second contact points spaced from each other for direct passage of current therebetween, and applying AC power on the electrodes through a resonant circuit coupled between a transformer receiving the AC power and the electrodes, the resonant circuit having inductance, capacitance, voltage and operating frequency properties set to control a maximum current flowing across the conductive load between the electrodes.

### BRIEF DESCRIPTION OF THE DRAWINGS

A detailed description of preferred embodiments will be given herein below with reference to the following drawings, in which like numbers refer to like elements.

FIG. 1 is a schematic diagram of a resonance controlled conductive heating apparatus according to the present invention, with a heated wire.

FIG. 2 is a schematic diagram of a resonance controlled conductive heating apparatus according to the present invention, without an inductor.

FIG. 3 is a schematic diagram illustrating the stray currents in a resonance controlled conductive heating apparatus according to the present invention with respect to a grounded metallic structure.

FIG. 4 is a schematic diagram of a resonance controlled conductive heating apparatus according to the present invention, in a three roller configuration.

FIG. 5 is a schematic diagram of a resonance controlled conductive heating apparatus according to the present invention, with a molten metal bath.

FIG. 6 is a schematic diagram of a resonance controlled conductive heating apparatus according to the present invention, with a heated tube.

FIG. 7 is a schematic diagram of a resonance controlled conductive heating apparatus according to the present invention, with a heating element.

### DETAILED DESCRIPTION OF THE PREFERRED EMBODIMENTS

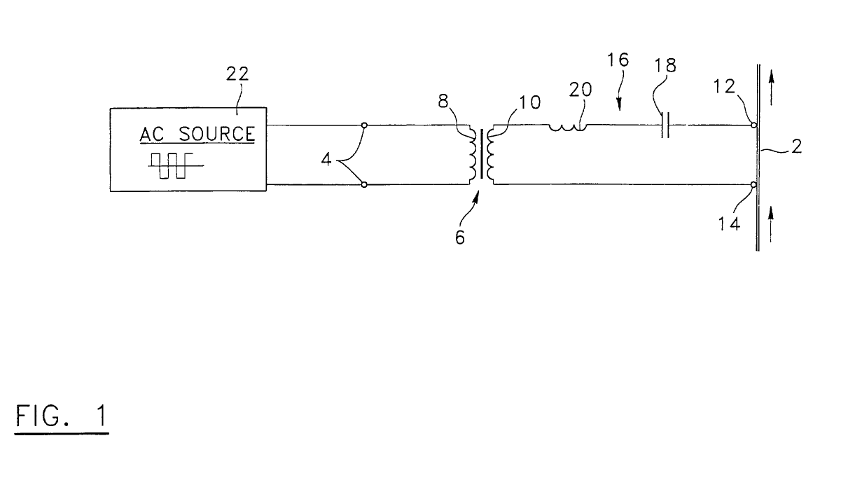

Referring to FIG. 1, there is shown a schematic diagram of a resonance controlled conductive heating apparatus according to the present invention for heating a conductive load 2, for example a running wire in the illustrated case. The apparatus has input terminals 4 for receiving AC power from an inverter or any other suitable power source 22. A transformer 6 has a primary winding 8 coupled to the input terminals 4, and a secondary winding 10 coupled to first and second electrodes 12, 14 adapted respectively to electrically engage the conductive load 2 at first and second contact points spaced from each other for direct passage of current between them. A resonant circuit 16 is coupled between the secondary winding 10 of the transformer 6 and the electrodes 12, 14. The resonant circuit 16 has inductance, capacitance, voltage and operating frequency properties set to control a maximum current flowing across the conductive load 2 between the electrodes 12, 14.

The resonant circuit 16 may be provided by a L-C series arrangement formed of a capacitor and an inductor 20, coupled between the secondary winding 10 of the transformer 6 and the first electrode 12.

The resonant frequency fc of the resonant circuit 16 is determined by the value of the capacitor 18 (C) and the total inductance (L) including the inductor 20 and the sum of the inductances due to the transformer 6 and the load 2. This frequency is determined by classical formula as:

$${f}_{C} = \frac{1}{2 π \sqrt{LC}}$$

The selection of the proper resonant frequency fc depends on the required power and also the total resistance variation of the load 2 (from cold start to process temperature), the eddy currents and the skin effect. This frequency can be from some hundred Hz to many tens of kHz.

The maximum power depends on the amount of material and temperature rise and losses. Depending on the physical size of the load 2, the effect of skin depth and eddy currents has to be added by considering the physical size of the load 2 (diameter in the case of a wire), the distance between the contact points of the electrodes 12, 14 with the load 2, the electrical properties of the load 2 such as its resistivity and its permeability.

The apparatus according to the present invention allows the coupling of the output of the inverter 22 to the load 2 without having the problems associated with the impedance variation and therefore benefits directly from the conduction heating and skin effect and eddy currents at higher frequencies, to heat-up loads and wires in a much faster and easier fashion. The presence of the capacitor 18 limits the maximum current passing the wire (or the load 2) in each half cycle. The maximum current is depending on neither the resistivity nor changes of the resistivity of the load 2. As in the nature of the AC current, an arc turns off at the end of each half cycle and therefor the arc is much weaker and less intense. The limited current, the independency of the current from the load variation and the quenching arc two times/cycle reduce the extent of the arcing and thus reduce possible damages on the surface of the wire or load 2 at the contact points. It also eases up heating the load 2 from cold start to hot temperature and adjusts the power consumption instantly and automatically, thereby allowing the implementation of the apparatus according to the present invention in wire heating industries and many others. The maximum delivered current is predetermined and depends on the value of the capacitor 18, the frequency of the AC source 22 with respect to the resonant frequency of the resonant circuit 16 and also the voltage of the capacitor 18. The maximum current flowing across the load 2 is not affected by changes in the load 2 or the quality of the contact points during the process. The selection of the resonant frequency fc and the power of the inverter 22 depend on the final resistance of the load 2, cross-section (diameter in the case of a wire), production speed, temperature, conductivity and permeability of the material. The kind and quality of the contact points have to be considered to compensate for the voltage and power losses at these points. Once these values are determined, the current in the capacitor 18 and thus in the load 2 is calculated as:

I_{C}=2πfCV

The maximum stored power in the resonant circuit 16 is determined by the L-C circuit parameters. This can be expressed using a classic formula as:

W=fCV²

The voltage drop across the contact points on the wire 2 and thus the consumed power on the wire 2 are internally determined by the resistivity of the wire 2 and the remaining energy is stored as resonance energy in the L-C circuit 16.

Here, the voltage across the wire 2 is varying depending on the resistivity of the wire 2, in that instance including variation with temperature. If the material is cold and has a minimum resistance, then all the current determined by the above formula is passed through the wire 2 with minimum generated heat and is stored in the capacitor bank with reverse polarity. The process continues in the next half cycle with reverse direction. When the material is heated gradually, more energy is consumed by the material as generated heat, each time the current is passed. The resistivity is increased gradually and thus the voltage drop across the wire 2 is increased automatically while the current remains constant as long as the capacitor 18 is charged by the inverter 22 to the same value in each cycle. The inverter charges the L-C circuit 16 depending on the consumed energy by the load 2.

The performance of the apparatus according to the present invention is detailed in the following example. In this example, f=20 kHz, V (capacitor)=500 V. As calculated in the previous example, the AC resistance of the wire 2 at cold start is 0,085 Ω and the power supply has to deliver 485 A. However during operation, when the wire is heated, its resistivity is increased to 0,34 Ω and 240 A at 82 V has to pass across the wire 2. The apparatus is then designed for this condition. In order to limit the current (I) to 240 A, the value of C is determined as:

C=½×π×f×V=3,8 μF

The stored energy in the capacitor bank is:

W=20000×3,8⁻⁶×500²=20 kW

With this value for the capacitor 18, the maximum current passing the wire 2 at cold start is limited to 240 A. The voltage drop would then be 20 V, generating about 5 kW energy. This power consumed from the L-C circuit 16 is charged back by the inverter 22 in the next cycle as long as the capacitor voltage is kept at 500 V as in this example.

With increasing the temperature to 900° C., the resistance of the wire 2 increases to 0,34 Ω and the voltage drop increases to 82 V and the power to 20 kW. The energy consumed by the load 2 from the oscillating resonant capacitor 18 is then replaced and charged from the power supply in the next cycle to 500 V or 20 kW. This results in a very simple and dynamic current source with a wide voltage-current range. In this way under any condition, the current rating of the apparatus will not exceed the predetermined values by the L-C circuit 16. The current will not exceed the current rating of the power supply, bus bars and contact points as designed during manufacturing even with complete short circuit.

In order to regulate and vary the power delivered to the resonant circuit 16 and thus the power delivered to the load 2, the operating frequency of the AC source 22 can be increased or decreased with respect to the resonant frequency fc. By moving away from the resonant frequency fc, the impedance of the circuit increases and thus less energy is transferred from the AC power source 22 to the resonant circuit 16. It is also possible to vary the magnitude of the delivered power by keeping the frequency of the inverter 22 close to the resonant frequency fc of the L-C circuit 16 and changing the amplitude of the voltage applied on the primary side of the transformer 6. This can be done simply by changing the duty cycle or DC voltage in the inverter circuit on the primary side of the transformer 6.

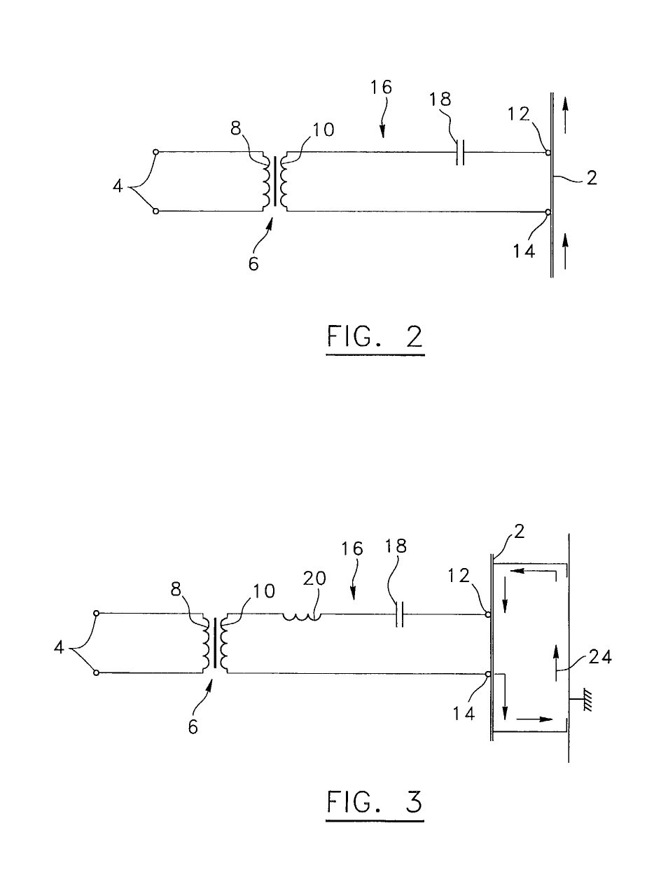

Referring to FIG. 2, in some cases, depending on the physical parameters of the system such as the distance between the contact points, the length of the bus bars and also the internal inductance of the power supply, it is possible to eliminate the inductor 20. In this case, the inductance in the resonant circuit 16 would be the sum of all other internal inductances in the electric path including the possible inductance of the load 2.

Referring to FIG. 3, in many industrial applications, it is desired to heat many wires or rods at the same time.

Installation of more than one apparatus as above described may cause grounding problem and unwanted stray currents across the metallic parts in contact with the passing wire 2 and the apparatus, such as a spooling mechanism, dies, guides, pick-ups. Such stray currents and grounding problems are depicted by arrows 24. Such currents cause cross-talking and arcing with other lines and even electrical shock and electrical hazards for the operator during mechanical handling of the wires, spooling, etc. with respect to the ground chassis and or other metallic parts. These problems are commonly experienced with conventional conduction heating with only two rollers or contact points.

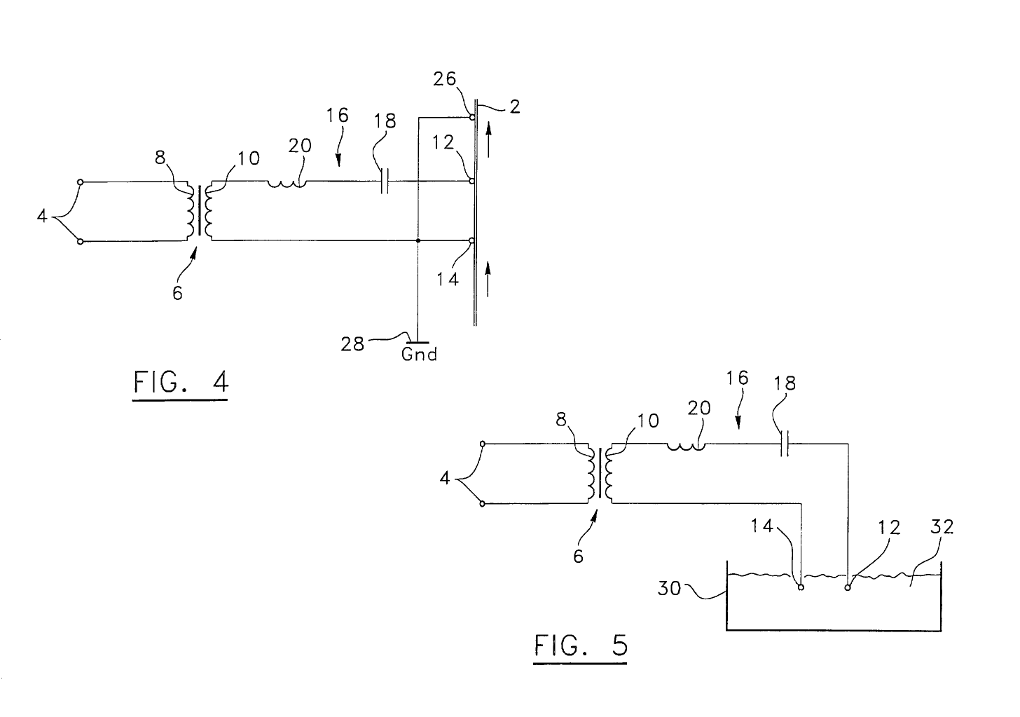

Referring to FIG. 4, in order to avoid these problems, three pairs of rollers or other kinds of contacting devices 12, 14, 26 are used. The middle roller unit 12 is connected to one of the line on the secondary side of the transformer 6, for example to the L-C circuit 16, while the two exterior roller units or collectors 14, 26 are connected to the other line on the secondary side of the transformer 6 and also to the ground and main chassis 28. By using three roller connections, grounding problems, sparks and electrical arcing between the wire 2 and guides and dies (not shown in the Figure) are eliminated. It also prevents cross-talking and arcing with other lines (not shown in the Figure) when many wires have to be heated by conduction. It eliminates electrical shock and hazards for the operator during mechanical handling of the wires, spooling, etc.

The order of placement and position of the L-C components 20, 18 are not important and they can be placed in a different position in the electrical circuit of the apparatus.

Referring to FIG. 5, the apparatus according to the invention can be used in many other industrial applications.

One of the major applications of high frequency conduction heating is to be used as in aluminum holding furnaces 30.

Here huge gas burners (not shown in the Figure) are used to maintain the temperature of molten metal 32. Almost all the aluminum smelters are using gas for holding furnaces. These furnaces are about 3×4 square meters (larger or smaller) and one or more gas burners of 2 to 5 MBTU provide the energy to keep the molten metal 32 for later operations. Due to the limited surface of the melt and the fact that the gas burner is on the top, the efficiency is very low and many MBTU/hr are lost in the air. By passing a high frequency current from the melt using the apparatus according to the present invention, melt can be heated with conduction heating. Due to high frequency current and thus formation of skin effect, only the top layer of the melt will carry the electricity. The set-up can be adapted without major modifications of the holding furnaces. Even gas burners can be left intact which gives assurance in the case of a malfunction occurring in the HF conduction apparatus. This increase of the resistance (comparing to bulk resistivity and heating when DC is used) can generate heat to hold the molten metal heated. The other advantage is that the melt would not be contaminated with gas product and problems associated with porosity will be eliminated.

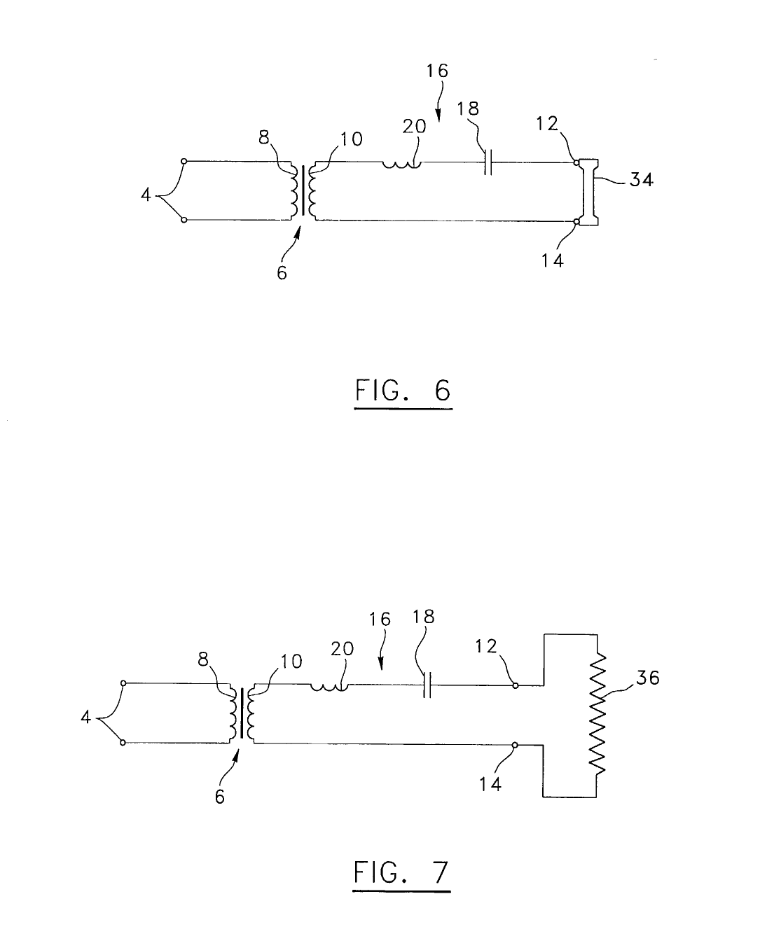

Referring to FIG. 6, another application of the apparatus according to the present invention is in heating steel tubes before galvanizing. Here, the contacts can be made in copper with pressure contacts like jaws. The tube 34 is placed between the two jaws made of copper or similar high conductivity materials. The jaws are closed and high frequency current is applied through the L-C circuit 16.

Referring to FIG. 7, there is shown a schematic diagram illustrating conductive heating where the heating elements 36 in a resistance furnace are heated by the apparatus according to the present invention. The resistance heating elements 36, such as conventional SiC or special high temperature alloys, can be made thicker and have a better lifetime and performance when heated by the present apparatus. A higher voltage is applied under lower current although the DC resistivity is low. This improves the current stresses on the elements 36, reduces the cost of high current transformer, cables and controllers and increases the lifetime of the heating elements 36.

There are many other applications in which HF conduction heating based on the present apparatus can be implemented such as: pre-heating of tubes for transferring molten aluminum; heat treatment of blades; heating pipes before galvanizing; annealing aluminum tubes; boiling liquids by passing them though a metallic tube heated as above; etc.

Referring back to FIG. 1, in accordance with the present invention, the conductive heating of the conductive load 2 is performed by electrically engaging the first and second electrodes 12, 14 with the conductive load 2 at first and second contact points spaced from each other for direct passage of current therebetween, and by applying AC power (provided by the AC source 22) on the electrodes 12, 14 through the resonant circuit 16 coupled between the transformer 6 receiving the AC power and the electrodes 12, 14, the resonant circuit having inductance, capacitance, voltage and operating frequency properties set to control the maximum current flowing across the conductive load 2 between the electrodes 12, 14.

In the case of an elongated element like a wire, either the electrodes (and the rest of the apparatus depending on its design) or the wire or both can be displaced during the process. In other cases like in the heating of a tube, the piece to be heated can be stationary.

The electrical contacts of the electrodes 12, 14 (and 28 if applicable) with the load 2 can be made through rollers, graphite electrodes, graphite brushes, collectors, sliding contacts, pressure contacts, clamps, or combination of them or of other suitable types of contacting devices.

The L-C circuit 16 limits the maximum current passing through the wire or conductive load 2 even at cold start and thus avoids strong arcing at the contact points. It also reduces the power rating of the power supply and connectors.

The maximum current is limited by the capacity, voltage and operating frequency of the capacitor and not by the electrical properties of the load 2. This circuit automatically and instantly matches the electrical variation of the load 2 with the power source 22. The magnitude of the delivered power is controlled by varying the frequency of the source 22 away or closer to the resonant frequency of the L-C circuit 16. The frequency of the source 22 is preferably higher than the resonant frequency but lower ones can also be used. The magnitude of the delivered power can also be controlled by keeping the frequency of the generator close or equal to the resonant frequency determined by the L-C circuit 16 and by changing the amplitude of the AC voltage applied on the primary side of the transformer 6. This amplitude can be varied by changing the duty cycle or value of DC voltage in an inverter circuit on the primary side of the transformer 6. With the addition of the L-C circuit 16, it is possible to transfer high frequency currents to different loads 2 and benefit from the increased AC resistivity of the metallic materials due to high frequency currents. Such high frequency currents generate additional heat by eddy currents and skin effect when the AC resistivity is increased. The other advantages comparing to conventional direct DC or 60 Hz conduction heating is that the arc at the contact points turns off at the end of each half cycle and therefore the arc is much weaker and less intense. These together limit the extent of arcing and reduce damages on the surface of the wire or load 2 at the contact points.

While embodiments of this invention have been illustrated in the accompanying drawings and described above, it will be evident to those skilled in the art that changes and modifications may be made therein without departing from the essence of this invention. All such modifications or variations are believed to be within the scope of the invention as defined by the claims appended hereto.

1. A resonance controlled conductive heating apparatus for heating a conductive load, comprising:
input terminals for receiving AC power;
a transformer having a primary winding coupled to the input terminals, and a secondary winding;
first and second electrodes coupled to the secondary winding of the transformer and adapted respectively to electrically engage the conductive load at first and second contact points spaced from each other for direct passage of current therebetween; and
a resonant circuit coupled between the secondary winding of the transformer and the electrodes, the resonant circuit having inductance, capacitance, voltage and operating frequency properties set to control a maximum current flowing across the conductive load between the electrodes.

2. The resonance controlled conductive heating apparatus according to claim 1, wherein the resonant circuit comprises a L-C series arrangement coupled between the secondary winding of the transformer and the first electrode.

3. The resonance controlled conductive heating apparatus according to claim 1, wherein the resonant circuit comprises a capacitor coupled between the secondary winding of the transformer and the first electrode, the inductance being provided by the transformer and a possible internal inductance of the conductive load.

4. The resonance controlled conductive heating apparatus according to claim 2, further comprising a third electrode connected to ground and to the second electrode, and adapted to electrically engage the conductive load at a third contact point spaced from the first contact point, the second and third electrodes being on opposite sides of the first electrode.

5. The resonance controlled conductive heating apparatus according to claim 1, wherein the electrodes comprise rollers, graphite electrodes, graphite brushes, collectors, sliding contacts, pressure contacts, clamps or a combination thereof.

6. The resonance controlled conductive heating apparatus according to claim 1, further comprising a means for varying a frequency of the AC power applied to the primary winding of the transformer away or closer to a resonance frequency of the resonant circuit.

7. The resonance controlled conductive heating apparatus according to claim 1, further comprising a means for controlling an amplitude of the AC power applied to the primary winding of the transformer.

8. The resonance controlled conductive heating apparatus according to claim 1, wherein the electrodes comprise means for maintaining electrical engagement of the electrodes with the conductive load during a relative displacement between the conductive load and the electrodes.

9. A method of performing conductive heating of a conductive load, comprising:
electrically engaging first and second electrodes with the conductive load at first and second contact points spaced from each other for direct passage of current therebetween; and
applying AC power on the electrodes through a resonant circuit coupled between a transformer receiving the AC power and the electrodes, the resonant circuit having inductance, capacitance, voltage and operating frequency properties set to control a maximum current flowing across the conductive load between the electrodes.

10. The method according to claim 9, further comprising varying a frequency or an amplitude of the AC power as a function of a desired amount of the current flowing across the conductive load.

11. The method according to claim 9, further comprising electrically engaging a third electrode with the conductive load at a third contact point spaced from the first contact point, the second and third electrodes being on opposite sides of the first electrode, the third electrode being connected to ground and to the second electrode.

12. The method according to claim 9, wherein the conductive load comprises a wire against which the electrodes are longitudinally applied, the method further comprising performing a relative displacement between the conductive load and the electrodes in a longitudinal direction of the wire.

13. The method according to claim 9, wherein the conductive load comprises a molten metal bath in which the electrodes are immersed.

14. The method according to claim 9, wherein the conductive load comprises a steel tube, the electrodes are provided with pressure jaws made of high conductivity materials and gripped to the steel tube, and the AC power has a high frequency.

15. The method according to claim 9, wherein the conductive load comprises a resistance heating element.
